(19) United States
(12) Patent Application Publication
(10) Pub. No.: US 2002/0104094 A1
(43) Pub. Date: Aug. 1, 2002

(54) System and method for processing video data utilizing motion detection and subdivided video fields

(76) Inventors: Bruce Alexander, Poulsbo, WA (US); Liem Bahneman, Bothell, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/007,136

(22) Filed: Dec. 3, 2001

Related U.S. Application Data
(60) Provisional application No. 60/250,912, filed on Dec. 1, 2000.
(60) Provisional application No. 60/281,122, filed on Apr. 3, 2001.

(51) Int. Cl. H04N 7/173

(52) U.S. Cl. 725/105

(57) ABSTRACT

A system and method for processing digital images are provided. A control server obtains digital images from one or more digital capture devices. The digital images can be processed to detect an event, such as movement. Additionally, user-defined zones may be further utilized to exclude specific areas or limit processing to specific areas.

### CROSS-REFERENCES TO RELATED APPLICATIONS

This application claims the benefit of U.S. Provisional Application No. 60/250,912 filed Dec. 1, 2000, and entitled SYSTEM AND METHOD FOR VIDEO BASED MOTION DETECTION. This application also claims the benefit of U.S. Provisional Application No. 60/281,122, filed Apr. 3, 2001, and entitled SYSTEM AND METHOD FOR SUBDIVIDING VIDEO FIELDS OF VIEW DURING VIDEO BASED MOTION DETECTION. U.S. Provisional Application Nos. 60/251,912 and 60/281,122 are incorporated by reference herein.

### FIELD OF THE INVENTION

In general, the present application relates to computer software and hardware, and in particular, to a method and system for processing digital video images utilizing motion detection and subdivided video fields.

### BACKGROUND OF THE INVENTION

Generally described, video cameras, such as digital video cameras, may be utilized to record still or moving images. In a digital camera, individual images are typically captured and stored as raw or compressed digital image data on various memory media (for example, a mass storage device or in a memory card). The digital image data can define property values for of a number of pixels, or picture elements, which are reproduced on a computer display screen or on a printing device. In a typical configuration, the digital image data comes in the form of a three-dimensional array for color images or a two-dimensional array for gray scale or black and white images. The height and width of the array represents what is referred to as the resolution of the digital image. Some common image resolutions are 1024 pixels by 768 pixels, 640 pixels by 480 pixels, and 320 pixels by 240 pixels. For both types of arrays, the first dimension defines an image width and the second dimension defines an image height. In the case of a three-dimensional color image array, the third dimension refers to red, green, and blue (RGB) values used to define a color for each pixel. However, in the case of gray scale images, the pixel is either black or white, so there is no need for a third dimension data.

Digital image data can be utilized to provide a variety of services, including security and surveillance services. In accordance with a digital video security or surveillance system embodiment, a combination of still and moving digital video image data from one or more digital video cameras is transmitted to a centralized monitoring location. The centralized monitoring location can utilize the video image data to detect unauthorized access to a restricted location, to verify the location of an identifiable object, such as equipment or personnel, to archive images, and the like.

In a conventional security monitoring system, the digital image data is transmitted to the central monitoring location and stored on mass storage devices for processing and archiving. However, storage of the raw digital image data becomes inefficient and can drain system memory resources. For example, in some three-dimensional arrays, each pixel is defined by 32 bits of color pixel data. Thus, storing a single digital image with a 1024 by 768-pixel resolution would require more than 2.25 Mbytes of memory. Because the video motion data includes a successive display on still images, the complete storage of each successive frame of image data inefficiently utilizes mass storage resources and can place an unnecessary strain on computing system processing resources.

Some computing systems attempt to mitigate the amount of memory required to store video motion digital image data in mass storage by utilizing various compression algorithms known to those skilled in the art, such as the Motion Pictures Expert Group (“MPEG”) algorithm. Generally described, many compression algorithms achieve a reduction in the size of a video motion file by introducing losses in the resolution of the image data. However, lossy compression algorithms in security or surveillance monitoring embodiments can become deficient for a variety of reasons. In one aspect, some compression algorithms reduce the number of digital image frames that are displayed to a user. In another aspect, some compression algorithms retain only a portion of successive video frame data corresponding to a detected charge. In both aspects, file size reduction is achieved by the elimination of data from the video image file. However, because security and surveillance embodiments often require images with high resolution, the effectiveness of most conventional compression algorithms is diminished.

In addition to the deficiencies associated with the storage of digital image data, many conventional security or surveillance systems require a human monitor to review the video data to detect a security event. However, dependency on a human monitor to detect specific events can become deficient in situations when the human monitor has to continuously monitor a display for a long period of time. Likewise, deficiencies can also occur if the human monitor is required to monitor multiple displays for a period of time. Generally described, conventional compression algorithms do not provide any additional processing functionality. Although some security or surveillance systems facilitate monitoring through the use of computerized processing, such as motion detection or image processing, the conventional security system typically requires the processing of the entire frame of the digital data. For example, most conventional algorithms will provide motion detection functionality to the entire video frame. This can often lead to diminished usefulness in the event the human monitor is only concerned with a specific portion of a video field of view. Accordingly, a human monitor cannot typically subdivide the monitored image frame to institute different security processing criteria or to select areas within a digital frame to monitor or process.

Still further, many conventional motion detection monitoring devices generally employ passive infrared (“PIR”) detectors. Current PIRs are continually being enhanced by adding ultrasonic or microwave sensors and digital signal processing. All of these devices work well in static environments and can be tailored for various settings by adjusting lens and mirror designs. Adjusting conventional motion detectors is a matter of physically tuning the device using manual tools. Accordingly, the use of the conventional PIR motion detection device becomes deficient in the event an often remote monitor is required to adopt an operable parameter of the PIR device.

Thus, there is a need for a system and method for evaluating video image data, while discriminating between desired and undesired video image data. Additionally, there is a need for subdividing digital video images into one or more processing areas.

### SUMMARY OF THE INVENTION

A system and method for processing digital video images are provided. A control server obtains digital images from one or more digital capture devices. The digital images can be processed to detect an event, such as movement. Additionally, user-defined zones may be further utilized to exclude specific areas or limit processing to specific areas.

In accordance with an aspect of the present invention, a method for processing digital image data is described. A processing serve obtains at least one processing zone for processing digital data obtained from one or more digital cameras. Each processing zone corresponds to a specific geometry. The processing server obtains a first and second frame of image data corresponding to one of the digital cameras. The processing server determines whether there is significant change between the first and second frames within the at least one processing zone. The determination of significant change is made by evaluating differential data corresponding to an adjustable parameter. The processing server then processes an event if a significant change is determined.

In accordance with another aspect of the present invention, a system for providing security monitoring is provided. The system includes one or more monitoring locations including at least one monitoring device operable to generate a video image and a central processing server operable to obtain the digital image and generate a user interface. The system further includes at least one display device operable to display the user interface and to obtain one or more processing zones corresponding to the image data. The central processing server processes the data according to the user's specified input.

In accordance with a further aspect of the present invention, a method for processing image data in a computer system having a graphical user interface including a display and a user interface device is provided. A processing server obtains a first frame of image data corresponding to an output from a video capture device. The processing server displays the first frame of data within a display area in the graphical user interface. The processing server obtains a designation of at least one processing zone from the user interface device. Each processing zone corresponds to a specific geometric shape within the display area and includes processing rule data. The processing server displays the processing zone within the display area of the graphical user interface. The processing server then obtains a second frame of image data corresponding to the output from the video capture device monitoring device. The processing server determines whether there is significant change between the first and second frames within the at least one processing zone. The determination of significant change is made by evaluating differential data corresponding to an adjustable parameter. Additionally, the processing server processes an event if a significant change is determined.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram of an Internet environment;

FIG. 2 is a block diagram of an integrated information portal in accordance with the present invention;

FIG. 3 is a block diagram depicting an illustrative architecture for a premises server in accordance with the present invention;

FIG. 4 is a block diagram depicting an illustrative architecture for a central server in accordance with the present invention;

FIG. 5 is a flow diagram illustrative of a digital image frame comparison process in accordance with the present invention;

FIG. 6 is a flow diagram illustrative of a multiple zone video motion sensing routine in accordance with the present invention; and

FIG. 7 is illustrative of a screen display produced by a WWW browser enabling a user to select and review the creation of processing zones within digital data frames.

### DETAILED DESCRIPTION OF THE PREFERRED EMBODIMENT

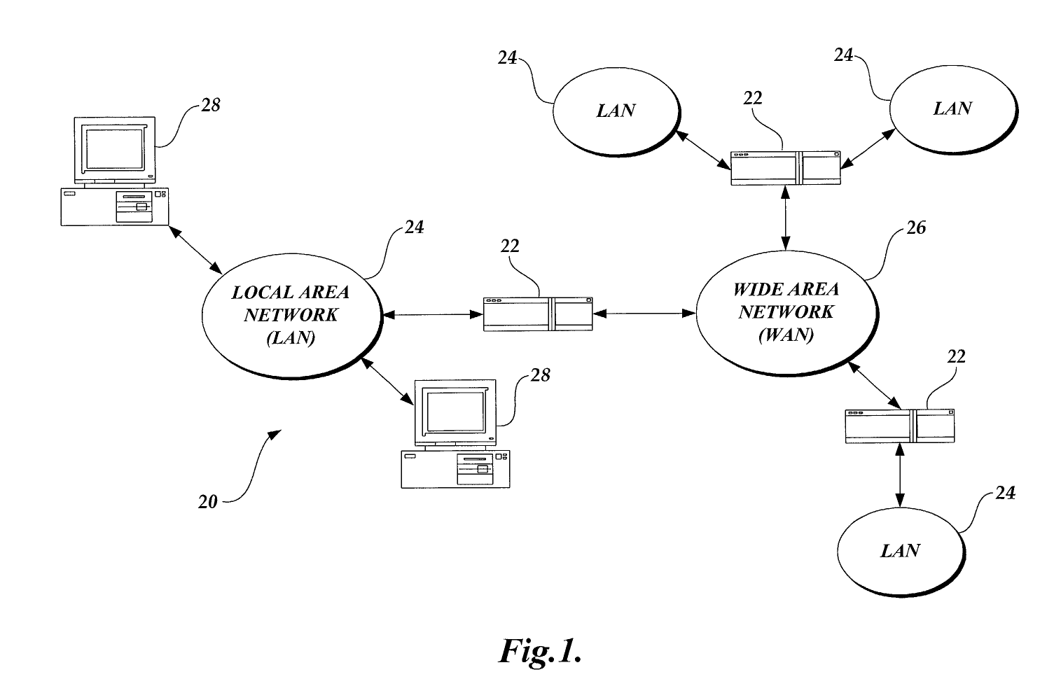

As described above, aspects of the present invention are embodied in a World Wide Web (“WWW” or “Web”) site accessible via the Internet. As is well known to those skilled in the art, the term “Internet” refers to the collection of networks and routers that use the Transmission Control Protocol/Internet Protocol (“TCP/IP”) to communicate with one another. A representative section of the Internet 20 is shown in FIG. 1, where a plurality of local area networks (“LANs”) 24 and a wide area network (“WAN”) 26 are interconnected by routers 22. The routers 22 are special purpose computers used to interface one LAN or WAN to another. Communication links within the LANs may be twisted wire pair, coaxial cable, or optical fiber, while communication links between networks may utilize 56 Kbps analog telephone lines, 1 Mbps digital T-1 lines, 45 Mbps T-3 lines, or other communications links known to those skilled in the art.

Furthermore, computers 28 and other related electronic devices can be remotely connected to either the LANs 24 or the WAN 26 via a modem and temporary telephone or wireless link. It will be appreciated that the Internet 20 comprises a vast number of such interconnected networks, computers, and routers and that only a small, representative section of the Internet 20 is shown in FIG. 1.

The Internet has recently seen explosive growth by virtue of its ability to link computers located throughout the world. As the Internet has grown, so has the WWW. As is appreciated by those skilled in the art, the WWW is a vast collection of interconnected or “hypertext” documents written in HyperText Markup Language (“HTML”) or other markup languages, which are electronically stored at “WWW sites” or “Web sites” throughout the Internet. Other interactive hypertext environments may include proprietary environments, such as those provided in America Online or other online service providers, as well as the “wireless Web” provided by various wireless networking providers, especially those in the cellular phone industry. It will be appreciated that the present invention could apply in any such interactive hypertext environments; however, for purposes of discussion, the Web is used as an exemplary interactive hypertext environment with regard to the present invention.

A Web site is a server/computer connected to the Internet that has massive storage capabilities for storing hypertext documents and that runs administrative software for handling requests for those stored hypertext documents. Embedded within a hypertext document are a number of hyperlinks, i.e., highlighted portions of text that link the document to another hypertext document possibly stored at a Web site elsewhere on the Internet. Each hyperlink is assigned a Uniform Resource Locator (“URL”) that provides the exact location of the linked document on a server connected to the Internet and describes the document. Thus, whenever a hypertext document is retrieved from any Web server, the document is considered retrieved from the World Wide Web. Known to those skilled in the art, a Web server may also include facilities for storing and transmitting application programs, such as application programs written in the JAVA® programming language from Sun Microsystems, for execution on a remote computer. Likewise, a Web server may also include facilities for executing scripts and other application programs on the Web server itself.

A consumer or other remote access user may retrieve hypertext documents from the World Wide Web via a Web browser program. A Web browser, such as Netscape's NAVIGATOR® or Microsoft's Internet Explorer, is a software application program for providing a graphical user interface to the WWW. Upon request from the consumer via the Web browser, the Web browser locates and retrieves the desired hypertext document from the appropriate Web server using the URL for the document and the HTTP protocol. HTTP is a higher-level protocol than TCP/IP and is designed specifically for the requirements of the WWW. HTTP runs on top of TCP/IP to transfer hypertext documents between server and client computers. The WWW browser may also retrieve programs from the Web server, such as JAVA applets, for execution on the client computer.

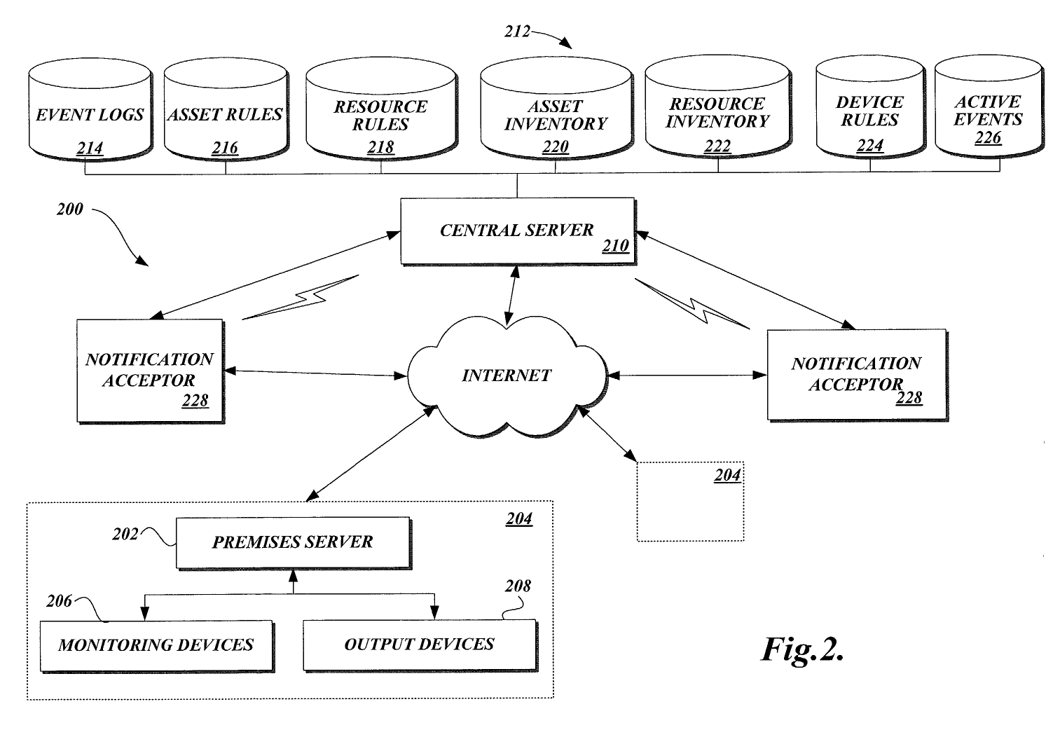

Referring now to FIG. 2, an integrated information system 200 for use with the present invention will be described. Generally described, an integrated information system 200 is a subscriber-based system allowing a number of monitoring devices within one or more premises to be monitored from a single control location. Additionally, the data from the monitoring devices is processed according to one or more rules. The control location customizes output of the processed data to a number of authorized users according to the preferences and rights of the user. While the system of the present invention is utilized to integrate traditional security monitoring functions, it is also utilized to integrate any information input in a like manner. Additionally, one skilled in the relevant art will appreciate that the disclosed integrated information system 200 is illustrative in nature and that the present invention may be utilized with alternative monitoring systems.

In an illustrative embodiment of the present invention, the integrated information system 200 includes one or more premises servers 202 located on any number of premises 204. The premises server 202 communicates with one or more monitoring devices 206. In an illustrative embodiment, the monitoring devices 206 can include digital capture devices, such as video cameras, digital still cameras, Internet-based network cameras, and/or similar monitoring devices for obtaining or generating digital image files. The monitoring devices 206 can also include non-digital motion cameras and still cameras and any additional components operable to convert image data into a digital format. The monitoring devices 206 can also include door and window contacts, glass break detectors, motion, audio, and/or infrared sensors. Still further, the monitoring devices 206 can include computer network monitors, voice identification devices, card readers, microphones and/or fingerprint, facial, retinal, or other biometric identification devices. Still further, the monitoring devices 206 can include conventional panic buttons, global positioning satellite (“GPS”) locators, other geographic locators, medical indicators, and vehicle information systems. The monitoring devices 206 can also be integrated with other existing information systems, such as inventory control systems, accounting systems, or the like. It will be apparent to one skilled in the relevant art that additional or alternative monitoring devices 206 may be practiced with the present invention.

The premises server 202 also communicates with one or more output devices 208. In an illustrative embodiment, the output devices 208 can include audio speakers, display or other audio/visual displays. The output devices 208 may also include electrical or electromechanical devices that allow the system to perform actions. The output devices 208 can include computer system interfaces, telephone interfaces, wireless interfaces, door and window locking mechanisms, aerosol sprayers, and the like. As will be readily understood by one skilled in the art, the type of output device 208 is associated primarily with the type of action the system produces. Accordingly, additional or alternative output devices 208 are considered to be within the scope of the present invention.

The premises server 202 is in communication with a central server 210. Generally described, the central server 210 obtains the various monitoring device data, processes the data, and outputs the data to one or more authorized users. In an illustrative embodiment, the communication between the central server 210 and the premises server 202 is remote and two-way. One skilled in the relevant art will understand that the premises server 202 may be remote from the premises or may omitted altogether. In such an alternative embodiment, the monitoring devices 206 transmit the monitoring data to a remote premises server 202 or alternatively, they transmit the monitoring data directly to the central server 210. Alternatively, one skilled in the relevant art will also appreciate that the premises server 202 may also perform one or more of the functions illustrated for the central server 210.

Also in communication with the central server 210 is a central database 212. In an illustrative embodiment, the central database 212 includes a variety of databases including an event logs database 214, an asset rules database 216, a resource rules database 218, an asset inventory database 220, a resource inventory database 222, an event rules database 224, and an active events database 226. The utilization of some of the individual databases within the central database will be explained in greater detail below. As will be readily understood by one skilled in the relevant art, the central database may be one or more databases that may be remote from one another. In an alternative embodiment, the central server 210 also maintains a device interface database for translating standard protocol-encoded tasks into device specific commands as will be explained in greater detail below. Accordingly, the central server 210 may perform some or all of the translation actions in accordance with the present invention.

With continued reference to FIG. 2, the central server 210 communicates with one or more notification acceptors 228. In an illustrative embodiment, the notification acceptors 228 can include one or more authorized users who are associated with the notification acceptor 228. Each authorized user has a preference of notification means and rights to the raw and processed monitoring data. The authorized users include premises owners, security directors or administrators, on-site security guards, technicians, remote monitors (including certified and non-certified monitors), customer service representatives, emergency personnel, and others. Moreover, the notification acceptor 228 may be a centralized facility/device that can be associated with any number of authorized users. As will be readily understood by one skilled in the art, various user authorizations may be practiced with the present invention. Additionally, it will be further understood that one or more of the rules databases may be maintained outside of the central server 210.

In an illustrative embodiment of the present invention, the central server 210 communicates with the notification acceptors 228 utilizing various communication devices and communication mediums. The devices include personal computers, hand-held computing devices, wireless application protocol enabled wireless devices, cellular or digital telephones, digital pagers, and the like. Moreover, the central server 210 may communicate with these devices via the Internet utilizing electronic messaging or Web access, via wireless transmissions utilizing the wireless application protocol, short message services, audio transmissions, and the like. As will be readily understood by one skilled in the art, the specific implementation of the communication mediums may require additional or alternative components to be practiced. All are considered to be within the scope of practicing the present invention.

In an illustrative embodiment of the present invention, the central server 210 may utilize one or more additional server-type computing devices to process incoming data and outgoing data, referred to generally as a staging server. The staging server may be a separate computing device that can be proximate to or remote from the central server 210, or alternatively, it may be a software component utilized in conjunction with a general-purpose server computing device. One skilled in the relevant art will appreciate communications between the central server 210 and the staging server can incorporate various security protocols known to those skilled in the relevant art.

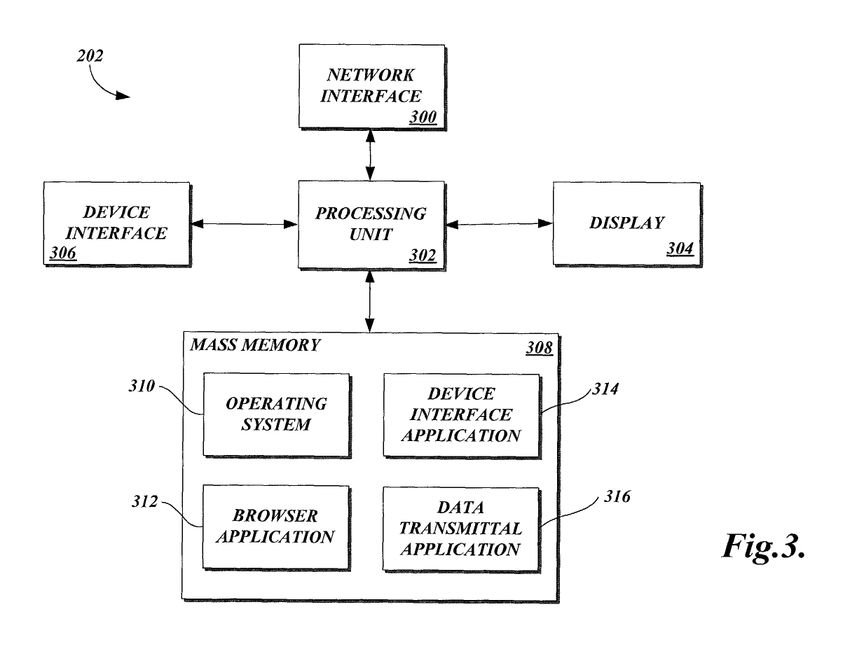

FIG. 3 is a block diagram depicting an illustrative architecture for a premises server 202 formed in accordance with the present invention. Those of ordinary skill in the art will appreciate that the premises server 202 includes many more components then those shown in FIG. 3. However, it is not necessary that all of these generally conventional components be shown in order to disclose an illustrative embodiment for practicing the present invention. As shown in FIG. 3, the premises server 202 includes a network interface 300 for connecting directly to a LAN or a WAN, or for connecting remotely to a LAN or WAN. Those of ordinary skill in the art will appreciate that the network interface 300 includes the necessary circuitry for such a connection, and is also constructed for use with the TCP/IP protocol or other protocols, such as Internet Inter-ORB Protocol (“IIOP”). The premises server 202 may also be equipped with a modem for connecting to the Internet through a point-to-point protocol (“PPP”) connection or a serial-line Internet protocol (“SLIP”) connection as known to those skilled in the art.

The premises server 202 also includes a processing unit 302, a display 304, a device interface 306 and a mass memory 308, all connected via a communication bus, or other communication device. The device interface 306 includes hardware and software components that facilitate interaction with a variety of the monitoring devices 206 via a variety of communication protocols including TCP/IP, X10, digital I/O, RS-232, RS-485 and the like. Additionally, the device interface facilitates communication via a variety of communication mediums including telephone landlines, wireless networks (including cellular, digital and radio networks), cable networks, and the like. In an actual embodiment of the present invention, the I/O interface is implemented as a layer between the server hardware and software applications utilized to control the individual digital image devices. One skilled in the relevant art will understand that alternative interface configurations may be practiced with the present invention.

The mass memory 308 generally comprises a RAM, ROM, and a permanent mass storage device, such as a hard disk drive, tape drive, optical drive, floppy disk drive, or combination thereof. The mass memory 308 stores an operating system 310 for controlling the operation of the premises server202. It will appreciated that this component may comprise a general-purpose server operating system as is known to those skilled in the art, such as UNIX, LINUX™, or Microsoft WINDOWS NT®T. The memory also includes a WWW browser 312, such as Netscape's NAVIGATOR® or Microsoft's Internet Explorer, for accessing the WWW.

The mass memory also stores program code and data for interfacing with various premises monitoring devices 206, for processing the monitoring device data and for transmitting the data to a central server. More specifically, the mass memory stores a device interface application 314 in accordance with the present invention for obtaining standard protocol-encoded commands and for translating the commands into device specific protocols. Additionally, the device interface application 314 obtains monitoring device data from the connected monitoring devices 206 and manipulates the data for processing by a central server 210, and for controlling the features of the individual monitoring devices 206. The device interface application 314 comprises computer-executable instructions which, when executed by the premises server, obtains and transmits device data as will be explained below in greater detail. The mass memory also stores a data transmittal application program 316 for transmitting the device data to the central server and to facilitate communication between the central server and the monitoring devices 206. The operation of the data transmittal application 316 will be described in greater detail below. It will be appreciated that these components may be stored on a computer-readable medium and loaded into the memory of the premises server 202 using a drive mechanism associated with the computer-readable medium, such as a floppy, CD-ROM, DVD-ROM drive, or network interface 300.

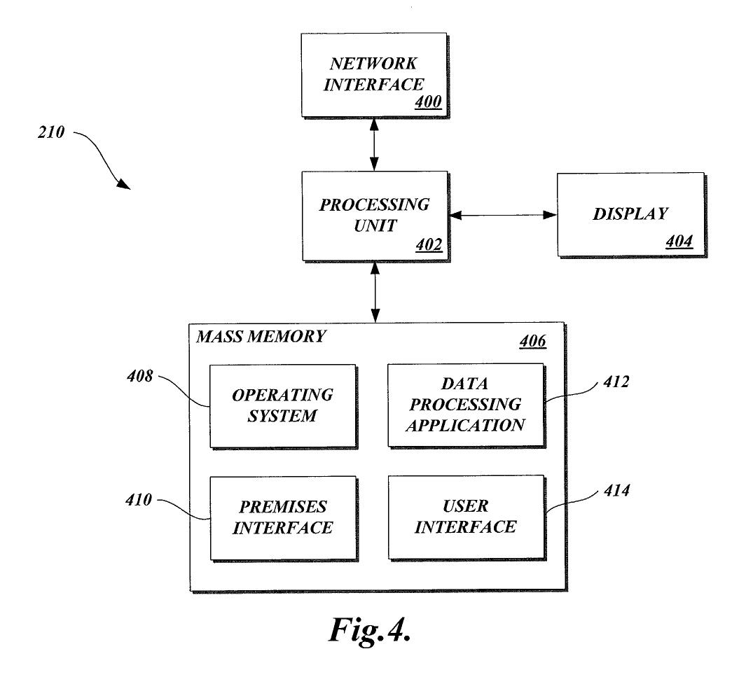

FIG. 4 is a block diagram depicting an illustrative architecture for a central server 210. Those of ordinary skill in the art will appreciate that the central server 210 includes many more components then those shown in FIG. 4. However, it is not necessary that all of these generally conventional components be shown in order to disclose an illustrative embodiment for practicing the present invention. As shown in FIG. 4, the central server 210 includes a network interface 400 for connecting directly to a LAN or a WAN, or for connecting remotely to a LAN or WAN. Those of ordinary skill in the art will appreciate that the network interface 400 includes the necessary circuitry for such a connection, and is also constructed for use with the TCP/IP protocol or other protocols, such as Internet Inter-ORB Protocol (“IIOP”). The central server 210 may also be equipped with a modem for connecting to the Internet through a PPP connection or a SLIP connection as known to those skilled in the art.

The central server 210 also includes a processing unit 402, a display 404, and a mass memory 406, all connected via a communication bus, or other communication device. The mass memory 406 generally comprises a RAM, ROM, and a permanent mass storage device, such as a hard disk drive, tape drive, optical drive, floppy disk drive, or combination thereof. The mass memory 406 stores an operating system for controlling the operation of the central server 210. It will be appreciated that this component may comprise a general-purpose server operating system as is known to those skilled in the art, such as UNIX, LINUX™, or Microsoft WINDOWS NT®. In an illustrative embodiment of the present invention, the central server 210 may also be controlled by a user through use of a computing device, which may be directly connected to or remote from the central server 210.

The mass memory 406 also stores program code and data for interfacing with the premises devices, for processing the device data, and for interfacing with various authorized users. More specifically, the mass memory 406 stores a premises interface application 410 in accordance with the present invention for obtaining data from a variety of monitoring devices 206 and for communicating with the premises server 202. The premises interface application 410 comprises computer-executable instructions that when executed by the central server 210, interface with the premises server 202 as will be explained below in greater detail. The mass memory 406 also stores a data processing application 412 for processing monitoring device data in accordance with rules maintained within the central server 210. The operation of the data processing application 412 will be described in greater detail below. The mass memory 406 further stores an authorized user interface application 414 for outputting the processed monitoring device data to a variety of authorized users in accordance with the security process of the present invention. The operation of the authorized user interface application 414 will be described in greater detail below. It will be appreciated that these components may be stored on a computer-readable medium and loaded into the memory of the central server 210 using a drive mechanism associated with the computer-readable medium, such as a floppy, CD-ROM, DVD-ROM drive, or network interface 400.

Prior to discussing the implementation of the present invention, a general overview of an integrated information system 200 in which the present invention can be implemented will be described. In an actual embodiment of the present invention, the monitoring device data is categorized as asset data, resource data or device data. Asset data is obtained from a monitoring device 206 corresponding to an identifiable object that is not capable of independent action. For example, asset data includes data obtained from a bar code or transponder identifying a particular object, such as a computer, in a particular location. Resource data is obtained from a monitoring device corresponding to an identifiable object that is capable of independent action. For example, resource data includes data from a magnetic card reader that identifies a particular person who has entered the premises. Event data is obtained from a monitoring device corresponding to an on/off state that is not correlated to an identifiable object. Event data is a default category for all of the monitoring devices. As will be readily understood by one skilled in the relevant art, alternative data categorizations are considered to be within the scope of the present invention.

The monitoring device data is obtained by the monitoring devices 206 on the premises server 202 and transmitted to the central server 210. The central server 210 receives the monitoring device data and processes the data according to a rules-based decision support logic. In an actual embodiment of the present invention, the central server 210 utilizes the databases 212 to store logic rules for asset data, resource data and event data. Moreover, because the monitoring device data is potentially applicable to more than one authorized user, multiple rules may be applied to the same monitoring device data. In an alternative embodiment, the databases 212 may be maintained in locations remote from the central server 210.

In the event the processing of the monitoring device rules indicates that action is required, the central server 210 generates one or more outputs associated with the rules. The outputs include communication with indicated notification acceptors 228 according to the monitoring device data rules. For example, an authorized user may indicate a hierarchy of communication mediums (such as pager, mobile telephone, land-line telephone) that should be utilized in attempting to contact the user. The rules may also indicate contingency contacts in the event the authorized user cannot be contacted. Additionally, the rules may limit the type and/or amount of data the user is allowed to access. Furthermore, the outputs can include the initiation of actions by the central server 210 in response to the processing of the rules. A more detailed description of an implementation of an integrated information system may be found in commonly owned U.S. application Ser. No. 08/825,506 entitled SYSTEM AND METHOD FOR PROVIDING CONFIGURABLE SECURITY MONITORING UTILIZING AN INTEGRATED INFORMATION SYSTEM, filed Apr. 3, 2001, which is incorporated by reference herein.

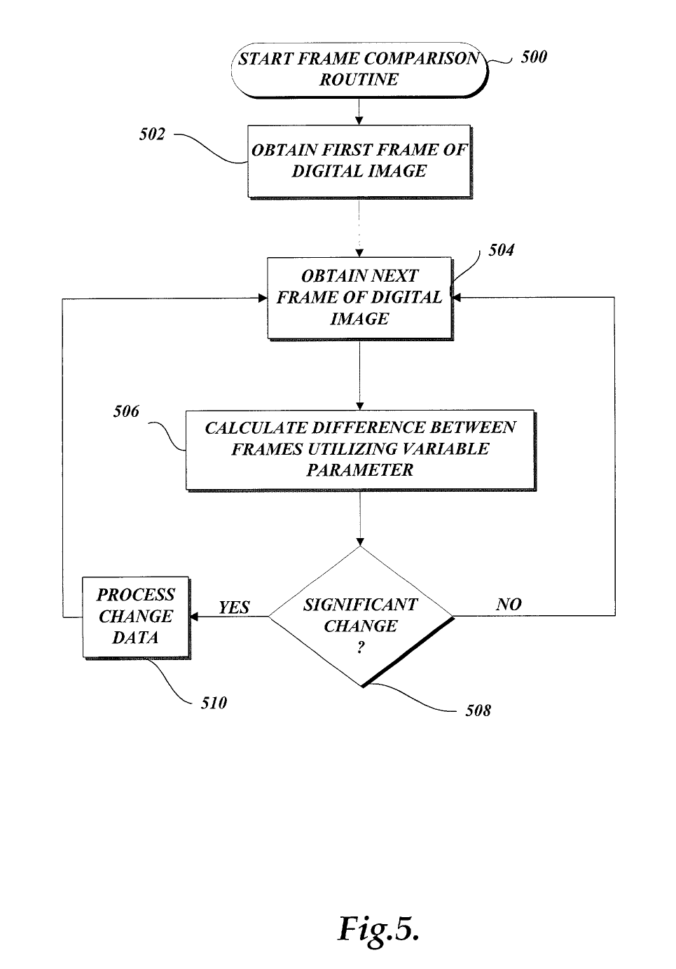

Generally described, the present invention facilitates the processing of digital images from any number of digital image devices in a monitoring network. In one aspect of the present invention, the present invention provides improved data management for creating images and for improved user control of various digital image devices. Specifically, the present invention utilizes a pixel comparison process to enable the improved data management. FIG. 5 is a block diagram illustrative of a pixel comparison process 500 in accordance with the present invention. At block 502, a first frame of data is obtained. At block 504, a second frame of digital data is obtained. In an illustrative embodiment of the present invention, the two frames of raw video are stored in RAM during the collection process.

At block 506, the difference between the two frames of data is calculated. At decision block 508, a test is done to determine whether the difference is significant. In an illustrative embodiment of the present invention, a pixel comparison process compares the pixel attributes of video frames in raw video format in the software layer. Each new frame is compared to the previous frame. Each matching red, green, or blue element of each color pixel (or each black and white pixel in gray scale images) is compared between the two frames. The difference between the two pixels (such as the difference between color RGB setting) is evaluated based on dynamically assigned tolerances.

In an illustrative embodiment of the present invention, the data processing application 412 of the control server 210 accepts a user-defined grid width setting that reduces the number of pixels actually compared. For example, the data processing application 412 can obtain user-specified commands such that the application will only consider a percentage of the total pixels in image. In one embodiment, the data processing application 412 may randomly sample a number of pixels in the image. In another embodiment, the data processing application may sample an ordered number of pixels, such as every third pixel. The sampling rate can be adjusted based on the user-selected grid weight. To measure the variance between the two samples, the total number of pixels that differ between the two frames are summed and divided by the total number of pixels in the sample. This statistical value may then be compared to a threshold value to determine whether the difference between the two samples may be considered significant. Additionally, in certain conditions the data processing application 412 may limit the pixel comparison to specific attributes of the pixel, such as color settings (red only, for example), to overcome unique environmental conditions. One skilled in the relevant art will appreciate that additional or alternative statistical processing or pixel sampling methods may be utilized with the present invention.

In another aspect of this embodiment, the data processing application 412 can also apply tolerances that ameliorate the effects of natural, mechanical, and electronic interference to the image or processing signal. As a result, this “signal noise” may be effectively ignored by data processing application 412 that enables the evaluation of video data to focus only on significant change. For example, the process can measure and detect change even at the individual RGB color or gray scale levels. Areas with outside lighting, outdoor cameras, or cameras in extremely sensitive areas in a facility will require site-specific settings. While the process ignores subtle environmental changes it is highly sensitive to the occurrence of rapid subtle change as well as gradual significant change.

Returning to decision block 508, if the change is not significant, the process 500 returns to block 504 to repeat the process. If, however, there is a significant difference between a new frame and an old frame, at block 510 a significant change data is reported for processing. In an illustrative embodiment, the system will record the image and potentially react in several ways. The reaction is determined by both the device parameters and reaction rules stored in the system database. For example, the rules may dictate that no other action is required. The rules may also dictate for the system to begin recording for a predetermined number of minutes and seconds. The system may also annotate a log file. Additionally, the system may generate an alarm and send a notification of the motion to an interested party. Further, the system executes a pre-determined action, such as turning on a light or an alarm. One skilled in the relevant art will appreciate that the rules may be pre-loaded on the system or may be user initiated and modified.

In another aspect of the present invention, a naming convention for mitigating the need to search through unwanted video files for viewing is provided. In accordance with this aspect of the present invention, a format is established for representing the digital image data. In an illustrative embodiment of the present invention, the naming schema “camX-EPOCHSECS.SEQ.jpg” is utilized where X represents the logical camera device, EPOCHSECS represents a timing convention (such as military time or relative time from an identifiable event and SEQ is a sequence from 0-n which represents the frame sequence within the whole second. For example, the SEQ data “0.0”, “0.1”, and “0.2”, would represent three frames within a current second of time. The use of the naming schema allows a playback application of the present invention to identify the desired files without searching for them. It can step sequentially through each sequence number until it hits one that does not exist and move on to the next second. To illustrate:

| Time (seconds): | Frame file name: |
|---|---|
| 1.0 | 100.0.jpg |
| 1.2 | 100.1.jpg |
| 1.4 | 100.2.jpg |
| 1.6 | 100.3.jpg |
| 1.8 | 100.4.jpg |
| 2.0 | 101.0.jpg |
| 2.2 | 101.1.jpg |

When replaying frames for the, “100^{th}” second, it would play back each sequential file 0.1, .2, .3, .4, until it cannot read 0.5 (file not found) then increment to 101 and reset the sequence to 0 for a new file of 101.0.

In an actual embodiment of the present invention, once the file name has been established the system will store the file in a directory structure matching the current date, where frames within a given minute are stored in a single directory. This further improves the search and retrieval process. For instance, the file CAMO-b 974387665100.0.jpg will be stored in the directory {base directory}/cam0/2000/11/15/14/00 (where cam0 is the device, 2000 is the CCYY, 11 is the month, 15 is the day of the month, 14 is the military clock hour, and 00 is the military clock minute. This process creates a directory system that allows significant amounts of video data to be stored and accessed in conventional file systems with fast and accurate methods.

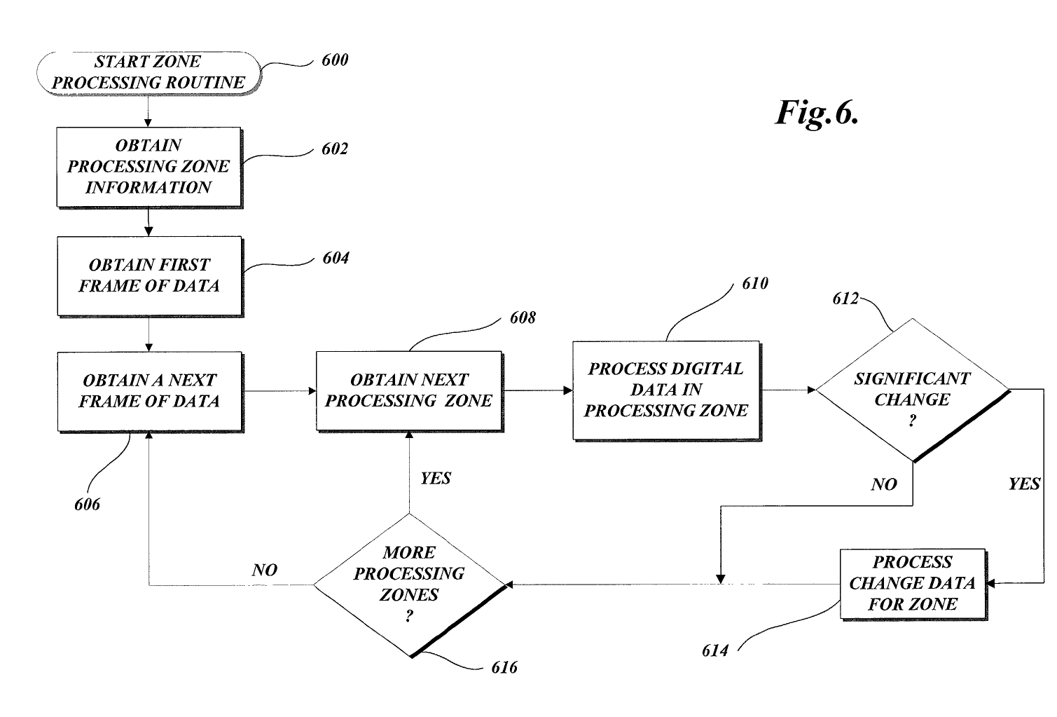

In another aspect of the present invention, a modified frame-comparison method may be utilized to specify areas to exclude frame evaluation. FIG. 6 is a flow diagram illustrative of a multiple zone video motion sensing routine implemented by the central server 210 in accordance with the present invention. At block 602, the user interface application 414 of the central server 210 obtains processing zone information for a selected digital camera monitoring devices 206 within the premises.

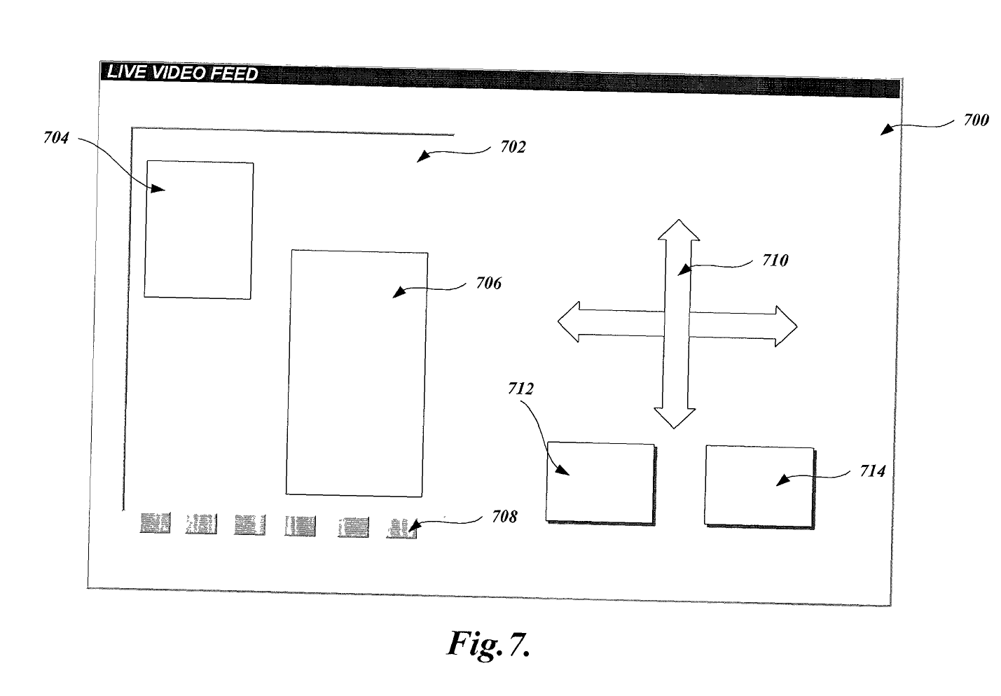

FIG. 7 is illustrative of a screen display 700 is produced by a WWW browser enabling a user to select and review the creation of processing zones within digital data frames. In an illustrative embodiment of the present invention, the user interface application 414 of the control server 210 generates a user control screen display 700 that is transmitted and displayed on the authorized user's computer via a WWW browser. The screen display 700 can include one or more graphical display areas 702 for displaying digital image data obtained from one or more digital camera monitoring devices 204. Each display area 702 can further include one or more individual processing zones that sub-divide the larger display area 702 and that can include independently modifiable display properties. As illustrated in FIG. 7, the screen display 702 includes a first processing zone 704 and a second processing zone 706. In accordance with an illustrative embodiment of the present invention, a user may designate display properties for a processing zone, such as zone 704, that will exclude the portion of image contained within the defined borders, such as a rectangle, from the image processing (e.g., motion detection). In a similar manner, a user may designate display properties of a processing zone, such as zone 706, in which the user can define specific processing rules that differ from processing rules from the remaining portion of the digital image. One skilled in the relevant art will appreciate that the processing zones may be created utilizing various geometric shapes, such as rectangles, squares, circles, and the like. Additionally, the processing zones may be created by manipulating graphical user interfaces, such as a mouse, light pen, touch pad, or roller ball. Alternately, the processing zones may be created and defined by geometric coordinates entered in through a keyboard or voice commands.

In an actual embodiment of the present invention, the user may define and name one or more processing zones during an initialization process prior to utilizing the integrated information system 200. Accordingly, the central server 210 can save the user selection and is able to recall the user selection. Additionally, the central server 210 may allow the user to adjust the saved settings at any time. Alternatively, the central server 210 may allow or require the user to define the processing zones as the data is being processed. In this alternative embodiment, the central server 210 may save the user's selection to allow the user to recall the settings for subsequent monitoring sessions. Moreover, the user may be able to recall a named processing zone to be applied to a different monitoring device. It will be appreciated by one skilled in the art that the ability to create named zones within a video filed of view enables different rules to be applied to the specific named zones. As a result, event data may be generated from only one named zone within a field of view and logged separately from the other named zones.

As further illustrated in FIG. 7, the screen display 700 can also include additional image controls 708 for manipulating the playback and recording of the digital image. The image controls 708 can include scanning controls, record controls, playback controls, and the like. Additionally, the screen display 700 can include device controls 710 for sending command signals to the monitoring devices 204. For example, the device controls 710 can include graphical interfaces for controlling the angle of display for a digital camera monitoring device 204. Still further, the screen display 700 can include additional image display areas 712 and 714 for displaying the output of additional monitoring devices 204. The display areas 712 and 714 may be of differing sizes and resolution. One skilled in the relevant art will appreciate that alternative user interfaces may be practiced with the present invention. Further, one skilled in the relevant art will appreciate that the user interface may be accessed by one or more remote computing terminals within the monitoring network. Additionally, each digital camera may also include a display capable of utilizing a user interface to control the digital camera.

In another embodiment of the present invention, each processing zone 704, 706 can include hyperlinks that can be graphically manipulated by a user to initiate additional processes on the image area defined by the processing zone. For example, the hyperlink may be capable of activating on output device 206, such as a loudspeaker, corresponding to the image area. Alternatively, the hyperlink may actuate a recording of the image data within the processing zone to a specific memory location, such as an external database. Still further, the hyperlink may initiate the generation of additional graphical user interfaces, additional controls within a graphical user interface, or cause the graphical user interface to focus on a selected processing zone.

Referring again to FIG. 6, at block 604, a first frame of data is obtained from the monitored device camera. At block 606, a second frame of digital data is obtained from the same device. In an illustrative embodiment of the present invention, the two frames of raw video are stored in RAM during the collection process.

At decision block 608, a next processing zone is obtained. One skilled in the relevant art will appreciate that in the first iteration of routine 600, there is at least one processing zone. Additionally, as will be explained in greater detail below, the routine 600 will repeat for any additional processing zones specified by the user. At block 610, the data processing application conducts a motion detection analysis between the first and second frames of digital data for the current processing zone. In an illustrative embodiment of the present invention, the motion detection analysis includes a pixel comparison process that compares the pixel attributes of video frames in raw video format in the software layer. Each pixel in the processing zone from the second frame is compared to the same pixel in the processing zone from the previous frame. Specifically, each matching red, green, or blue element of each color pixel (or each black and white pixel in gray scale images) is compared between the two frames. The difference between the two pixels (such as the difference in the color RGB settings) is evaluated based on dynamically assigned tolerances.

As explained above, in an illustrative embodiment of the present invention, the data processing application 412 of the central server 210 can accept a user-defined grid width setting within the processing zone that provides a statistical analysis of the digital image. In one example, the pixel differences for the two frames are summed and divided by the total number of pixels in the sample. The resulting quotient identifies the percentage of change between the frames. One skilled in the relevant art will appreciate that additional or alternative statistical processing may also be utilized. Moreover, one skilled in the relevant art will also appreciate that additional or alternative motion detection processes may also be practiced with the processing zones of the present invention.

At decision block 612, a test is performed to determine if the change is significant. In an illustrative embodiment of the present invention, the user may define one or more ranges within the zone for establishing a threshold amount of movement that qualifies as a significant amount of change. The threshold amount of movement may be based on user input or may be based on an adjustable scale.

If there is a significant difference between a new frame and an old frame within the zone, at block 614, the data processing application 412 process the zone data as a significant change. In an illustrative embodiment, the system will record the image and potentially react in several ways. Both the device parameters and reaction rules stored in the system database can determine the reaction. For example, the rules may dictate that no other action is required. The rules may also dictate for the system to begin recording for a predetermined number of minutes and seconds. The central server 210 may also annotate a log file. Additionally, the central server 210 may generate an alarm and send a notification of the motion to an interested party. Further, the central server 210 executes a predetermined action, such as turning on a light or an alarm. Still further, the activation of the motion detector can be registered as event data will test for motion within additional specified zones. One skilled in the relevant art will appreciate that the rules may be pre-loaded on the system or may be user initiated and modified.

In the event that the detected motion is not significant at block 612, or once the zone data has been processed at block 614, the routine proceeds to decision block 516. At decision block 616, a test is done to determine whether there are additional processing zones. If there are additional processing zones specified within the frame that have not been processed, the data processing application repeats blocks 608-614. However, if there are no further processing zones, the routine 600 returns to block 606 to process the next frame of data.

In a further aspect of the present invention, the data collected during routine 500 or routine 600 could be used to independently control aspects of the camera. For instance, some cameras are capable of being directed to a specific elevation and azimuth through remote software links. Using logical location relationships the current invention can relate camera behavior through motion detection by pointing the camera in a given direction to center the area of movement. In addition, the motion detected by the camera can be used to trigger actions such as turning on lights, playing an audio recording, or taking any other action that can be initiated through software interfaces and relays.

In another illustrative embodiment of the present invention, routine 500 or routine 600 could be used to aim a camera or another device. In the event that motion is detected, an unattended digital camera can be incrementally directed toward the motion. Because the method uses camera feedback to control the camera, information collected from the camera drives the camera control. As a result, several cameras can be used to keep a moving object continuously centered in the field of view. The incremental tracking avoids negative feedback from the camera while enabling centering.

In a further illustrative embodiment of the present invention, the defined-area method for pixelated motion detection could be utilized to monitor ingress or egress to an access-controlled area. In this illustrative embodiment, the video image data, through a processing zone, is defined by a user to graphically cover an area of a digital frame corresponding to the entryway. In one aspect, the integrated information system 200 may be configured to detect whether more than one person enters a limited access area. In conjunction with an access device such as a proximity card, access code, doorbell, key, or other device, the processing zone is configured to detect whether multiple human forms pass through the processing zone when the entryway is opened. Thus, the interpreted information system 200 can report a violation and the monitoring network can react accordingly.

In another illustrative embodiment of the present invention, a processing zone may be configured to detect whether there are any obstacles in the path of a vehicle or other moving object. For example, a processing zone may be set up in a driveway or loading zone to detect any movement, or other obstacle, as a car or truck is backing up. If the data processing application 414 detects an object along the graphically defined path, the integrated information system 200 can alert the driver.

In yet another illustrative embodiment, one or more processing zones could be used to identify a change in the expected number of people or other items in a certain location. For example, the control server 210 can be configured to control/monitor the ingress/egress of people from a large facility. In the event of an emergency (such as a fire in a stadium or auditorium) the movement of a large number of people toward a certain exit could prompt a mediating response for better (safer) crowd control. This would also be relevant for non-emergency crowd control. The method could also be used to detect an accumulation of people at an unusual time. A group of people assembled outside a public/private building in the middle of the night could be a mob or another event requiring monitoring or review that would not be otherwise have been identified as an alarm event.

In still a further illustrative embodiment of the present invention, the control server could utilize color for surveillance or tracking within a processing zone. For example, witnesses often identify a suspect by the color of an article of clothing. If the system were configured to detect specific colors, including shading, the detection of an object conforming to the specific color, would be processed as an alarm event.

In another illustrative embodiment, an environmental change-such as smoke-could be detected by video and be processed by an alarm event. One skilled in the relevant art will appreciate that the presence of smoke alters the digital images obtained by a digital camera. Accordingly, the control server 210 could be configured to utilizing a color analysis and/or a zone analysis to detect image changes produced by smoke within an area.

While illustrative embodiments of the invention have been illustrated and described, it will be appreciated that various changes can be made therein without departing from the spirit and scope of the invention.

The embodiments of the invention in which an exclusive property or privilege is claimed are defined as follows:

1. A method for processing image data, the method comprising:
obtaining at least one processing zone for processing digital data obtained from one or more digital capture devices, wherein the at least one processing zone corresponds to a specific geometry;
obtaining a first frame of image data corresponding to one of the digital capture devices;
obtaining a second frame of image data corresponding to the digital capture device;
determining whether there is significant change between the first and second frames within the at least one processing zone, wherein the determination of significant change is made by evaluating differential data corresponding to an adjustable parameter; and
processing an event if a significant change is determined.

2. The method as recited in claim 1, wherein the specific geometry of the processing zones is characterized by a rectangle.

3. The method as recited in claim 1, wherein the specific geometry of the processing zone is characterized by a circle.

4. The method as recited in claim 1, wherein the specific geometry is graphically displayed through a user interface.

5. The method as recited in claim 4, wherein the specific geometry includes a hyperlink to one or more monitoring devices capable of input or output to a physical location that corresponds to the processing zone.

6. The method as recited in claim 1, wherein evaluating the differential data includes statistically comparing a sample of pixels within the first and second frame of image data.

7. The method as recited in claim 1, wherein evaluating the differential data includes evaluating specific color data for individual pixels.

8. The method as recited in claim 1, wherein the adjustable parameter corresponds to a number of pixels to be compared.

9. The method as recited in claim 8, wherein the adjustable parameters are entered through a graphical user interface.

10. The method as recited in claim 9, wherein the graphical user interface is a WWW browser user interface.

11. The method as recited in claim 1, wherein the adjustable parameter is dynamically modified.

12. The method as recited in claim 1, wherein multiple processing zones are obtained from one or more frames of video, wherein at least one processing zone is evaluated using a parameter different from the at least one parameter used in the previously selected processing zone within the one or more frames of video.

13. The method as recited in claim 12, wherein at least one processing zone excludes an area from evaluation.

14. The method as recited in claim 1, wherein processing an event includes executing user-defined sequences if a significant change is determined.

15. The method as recited in claim 14, wherein processing an event includes sounding alarm.

16. The method as recited in claim 14, wherein processing an event includes archiving video data.

17. The method as recited in claim 16, wherein archiving the video includes storing the video data in a file directory corresponding to given time period.

18. The method as recited in claim 17, wherein archiving the video includes naming the file directory according to a time of the day.

19. A computer-readable medium having computer-executable instructions for performing the method recited in claim 1.

20. A computer system having a processor, a memory, and an operating environment, the computer system operable to perform the method recited in claim 1.

21. A system for providing security monitoring, the system comprising:
one or more monitoring locations including at least one monitoring device operable to generate a video image;
a central processing server operable to obtain the digital image and generate a user interface;
at least one monitoring computing device operable to display the user interface and to obtain one or more processing zones corresponding to the image data, wherein the central processing server processes the data according to the user's specified input.

22. The system as recited in claim 21, wherein the specific geometry of the processing zone is characterized by a rectangle.

23. The system as recited in claim 21, wherein the specific geometry of the processing zone is characterized by a circle.

24. The system as recited in claim 21, wherein the specific geometry is graphically displayed through the user interface.

25. The system as recited in claim 24, wherein the specific geometry includes a hyperlink to one or more monitoring devices capable of input or output to a physical location that corresponds to the processing zone.

26. The system as recited in claim 21, wherein the central processing server is further operable to statistically compare a sample of pixels within a first and second frame of image data.

27. The system as recited in claim 21, wherein the central processing server is further operable to evaluate specific color data for individual pixels of a first and second frame.

28. The system as recited in claim 21, wherein the central processing server is operable to process the image data according to an adjustable parameter.

29. The system as recited in claim 28, wherein the adjustable parameter is user specified through the graphical user interface.

30. The system as recited in claim 28, wherein the adjustable parameter is dynamically modified.

31. The system as recited in claim 21, wherein the graphical user interface includes multiple processing zones, and wherein at least one processing zone is evaluated using a parameter different from at least one parameter used in the other processing zone.

32. The system as recited in claim 31, wherein at least one processing zone excludes an area from evaluation.

33. The system as recited in claim 31, wherein the central processing server is further operable to process an event according to a user-defined sequence.

34. The system as recited in claim 33, wherein processing an event includes sounding the alarm.

35. The system as recited in claim 33, wherein processing an event includes archiving video.

36. The system as recited in claim 35, wherein archiving video includes storing the video data in a file directory corresponding to a given period of time.

37. The system as recited in claim 36, wherein archiving the video includes naming the file directory according to a time of day.

38. In a computer system having a graphic user interface including a display and a user interface device, a method for processing image data, the method comprising:
obtaining a first frame of image data corresponding to an output from a digital capture device;
displaying the first frame of data within a display area in the graphical user interface;
obtaining a designation of at least one processing zone from the user interface device, wherein the processing zone corresponds to a specific geometric shape within the display area and includes processing rule data;
displaying the processing zone within the display area of the graphical user interface;
obtaining a second frame of image data corresponding to the output from the digital capture device;
determining whether there is significant change between the first and second frames within the at least one processing zone, wherein the determination of significant change is made by evaluating differential data corresponding to an adjustable parameter; and
processing an event if a significant change is determined.

39. The method as recited in claim 38, wherein the geometric shape of the processing zones is characterized by a rectangle.

40. The method as recited in claim 38, wherein the geometric shape of the processing zone is characterized by a circle.

41. The method as recited in claim 38, wherein the processing zone includes a hyperlink to one or more monitoring devices capable of input or output to a physical location that corresponds to the processing zone.

42. The method as recited in claim 38, wherein evaluating the differential data includes statistically comparing a sample of pixels within the first and second frame of image data.

43. The method as recited in claim 38, wherein evaluating the differential data includes evaluating specific color data for individual pixels.

44. The method as recited in claim 38, wherein the adjustable parameter corresponds to a number of pixels to be compared.

45. The method as recited in claim 44, wherein the adjustable parameters are entered through a graphical user interface.

46. The method as recited in claim 38, wherein the graphical user interface is a WWW browser user interface.

47. The method as recited in claim 38, wherein the adjustable parameter is dynamically modified.

48. The method as recited in claim 38 further comprising obtaining a designation of a second processing zone from the user interface device, wherein the second processing zone corresponds to a specific geometric shape within the display area and includes processing rule data, and wherein the processing rule data is different from the processing rule data from the previously designated processing zone.

49. The method as recited in claim 48, wherein at least one processing zone excludes an area from evaluation.

50. The method as recited in claim 38, wherein processing an event includes executing user-defined sequences if a significant change is determined.

51. The method as recited in claim 50, wherein processing an event includes sounding alarm.

52. The method as recited in claim 50, wherein processing an event includes archiving video data.

53. The method as recited in claim 52, wherein archiving the video includes storing the video data in a file directory corresponding to given time period.

54. The method as recited in claim 52, wherein archiving the video includes naming the file directory according to a time of the day.

55. A computer-readable medium having computer-executable instructions for performing the method recited in claim 38.

56. A computer system having a processor, a memory, and an operating environment, the computer system operable to perform the method recited in claim 38.
